(19) United States
(12) Patent Application Publication
(10) Pub. No.: US 2005/0160082 A1
(43) Pub. Date: Jul. 21, 2005

(54) System and method of context-specific searching in an electronic database

(75) Inventor: Kevin Dawson, Sacramento, CA (US)

Correspondence Address: CARPENTER & KULAS, LLP, 1900 EMBARCADERO ROAD, SUITE 109, PALO ALTO, CA, 94303, US

(73) Assignee: The Regents of the University of California, Oakland, CA (US)

(21) Appl. No.: 10/768,034

(22) Filed: Jan. 30, 2004

Related U.S. Application Data
(63) Continuation-in-part of application No. 10/759,784, filed on Jan. 16, 2004.

(51) Int. Cl. G06F 7/00

(52) U.S. Cl. 707/3

(57) ABSTRACT

A user can search a database within a “context” that can be invoked with a context term, or name. The context is pre-defined by a human expert, or curator. The context definition is used in conjunction with a search term provided by the user to efficiently obtain search results that can otherwise be difficult to attain, such as detecting characteristics of data over multiple documents or other database items to infer trends, phenomena, characteristics, or other properties of the data. A context can be a category of items where each item has a distinct name. Search results are presented using the context based on the number of co-occurrences of the search term and terms relating to the context. In a preferred embodiment, the search results are presented as a list with documents having higher co-occurrences ordered at the top of the list. Context definition sets can be created and updated as an ongoing service to a subscriber. Several processing configurations are presented.

### STATEMENT AS TO RIGHTS TO INVENTIONS MADE UNDER FEDERALLY SPONSORED RESEARCH OR DEVELOPMENT

This invention was made with Government support awarded by the NCMHD/NIH. The Government has certain rights in this invention.

### NOTICE OF COPYRIGHT DISCLAIMER

A portion of the disclosure recited in the specification contains material which is subject to copyright protection. Specifically, a Source Code Appendix is included that lists source code instructions for a process by which the present invention is practiced in a computer system. Other portions of the application may also recite or contain source code or other functional definitions. The copyright owner has no objection to the facsimile reproduction of the source code and functional definitions, otherwise all copyright rights are reserved.

### BACKGROUND OF THE INVENTION

This invention is related in general to electronic database systems and more specifically to database searches and presentation of database search results using context information.

The proliferation of information in electronic databases has been a boon to many areas of science, education, business and recreation. However, the tremendous amount of information now available from these databases can also be overwhelming. In order to help users find desired search results in large databases many search tools and techniques have been developed.

For example, a popular type of database query includes a simple “keyword” search. A user may desire information, for example, on a specific chemical compound and can request all articles in a scientific database that include the compound's name. The user may be able to-request only those articles that have the compound name in a specific section of a document, such as a document title. The simple keyword search query can work well when the number of documents that include the keyword are relatively few, such as when the compound name is not commonly used.

Usually, however, a search using a single simple keyword will result in many “hits” or documents containing the keyword. For example, a search using the term “alcohol” can turn up hundreds of thousands of documents in a large database. The search can be narrowed by adding additional terms that are relevant to the information that a user seeks. For example, if a user is interested in the effects of alcohol on traffic accidents the user can perform for additional terms such as “driving under the influence,” “accident,” “blood alcohol level,” etc. The inclusion of additional search terms can narrow the search results to a manageable level of a few dozen documents. Typically the document titles, or other brief summary information, are displayed to the user. The user can then scan the documents' identifying information and decide which full documents to retrieve for further review.

Today's database search engines may also allow “relational operators” in the search queries. For example, keywords or terms can be combined with the relational operators AND, OR, NOT, etc. Thus, a search query can be formed as “alcohol AND (blood OR level) AND 0.8 AND NOT below”. Other types of queries allow specifying portions of words (e.g., with “wild cards” or “meta-characters”), or conditions such as a condition that words or phrases must be within a certain distance from one another. Other search operators or conditions are possible. However, relational searching is often cumbersome and requires a user to have sophisticated knowledge and experience in building successful queries.

Another aid to searching databases lies in the databases, themselves. Often a database can be tailored to a specific topic or type of information. For example, a medical database may include medical reports or journals in a uniform format. A government organization, such as the U.S. Patent Office, maintains hundreds of thousands of documents over decades that include different categories or sections in each document, cross references, specific abbreviations, codes and other formats, etc. If a user is familiar With the source, format and maintenance of information in a database, then the user is more likely to be able to create successful queries with less effort.

Database languages, such as SQL, etc., allow very complex and flexible search queries. However, the effective use of these languages is beyond the ability of many of today's typical users. Due to the widespread availability of databases via digital networks, such as corporate, campus or home local area networks; or wide-area networks such as the Internet, database accessing has become invaluable for many people who are not skilled in database search languages.

One problem for a typical database user is that approaches such as using keywords and simple relational search queries are designed to find a single, or few, “best” documents. However, today's users often desire to use the information in a database to perceive trends or other properties of information, or to answer questions that require a more comprehensive or global assessment of items in a database. Such database “mining” or investigation can often lead to valuable new ideas, business opportunities, or other advantages.

For example, a researcher may want to know what genes play a role in biological processes involving calcium, such as calcium metabolism, calcium signaling, etc. With today's typical search tools such an inquiry can be very difficult or impossible for an average (or even an expert) user to formulate since the set of gene names is constantly growing and changing as new gene names and gene name variants are rapidly being discovered, reclassified, modified, etc. A user in a prior art system might try to discover names of specific genes that play a role in calcium processing by using the search term “calcium AND genes” (or merely “calcium genes” where the “AND” is inferred) to find documents with the word “calcium” co-occurring with the word “gene.” But performing such a search, for example, in the popular PubMed medical research database at, e.g., www.pubmed.com, returns a list of 6988 document titles through which the user must search to discover gene names that are relevant.

Even if a user knows names of all genes that play a role in calcium processing, the prior art approach typically requires a time-consuming entry of each specific gene name with the keyword “calcium” or other terms or search strategies. Each separate search of gene names is performed in isolation of previous searches so that correlation among the searches to arrive at valuable conclusions about genetics and calcium processing is very difficult.

### SUMMARY OF THE INVENTION

A preferred embodiment of the invention allows a user to search a database within a “context” that can be invoked with a context term, or name. The context is pre-defined by a human expert or curator and can also be defined or updated automatically. The context definition is used in conjunction with a search term provided by the user to efficiently obtain search results that can otherwise be difficult to attain, such as detecting characteristics of data over multiple documents or other database items to infer trends, phenomena, characteristics, or other properties of the data.

In one embodiment, a context can be a category of items where each item has a distinct name. For example, the context of “genes” can include a list of hundreds or thousands of gene names associated with the context name by the curator. When a user selects the context of “genes” in a search that also includes the user's search term, the list of gene names is exhaustively paired with the search term to obtain a count of documents in a database in which both the gene name and user search term are present.

Search results are presented using the gene names based on the number of co-occurrences of the search term and gene name in database documents. In a preferred embodiment, the search results are presented as a list with the gene names of higher co-occurrence at the top of the list. In this manner, a user can quickly determine which gene names (out of tens of thousands of gene names) may be implicated by the search term.

Context definition sets can be created and updated as an ongoing service to a subscriber, such as a university, business or other entity. The context definition sets can be created with the assistance of specialized authoring tools. Users can modify, or customize, the sets as desired for specific applications. Use restrictions, or access rights, can be enforced to enhance a business model whereby context definition set authors can control revenue from the use, transfer, modification, or other properties or characteristics of context definition information.

Several processing configurations are presented. In a preferred embodiment, a user communicates with a context server. The context server is in communication with an originating database. The originating database stores the base, or underlying documents, that are the target of the user's search. The context server interrogates the originating database and can pre-compile lists or other information to assist in context searches that may be invoked by the user at a later time.

In one embodiment the invention provides a method for searching a database, the method executing in a system including a user input device and a user output device, the method comprising accepting first and second search terms from the user input device, wherein the second term is associated with a predetermined list of two or more names; identifying documents from the database that satisfy the first search term; determining the frequency of occurrence of the two or more names in the identified documents; presenting at least a portion of the identified documents to a user by using the output device, wherein the presented identified documents are ordered according to the determined frequency of occurrence of the two or more names.

In another embodiment the invention provides a method for searching a database having items, the method executing in a system including a user input device and a user output device, the method comprising accepting first and second search terms from the user input device, wherein two or more associated terms are associated with the second search term; and indicating a search result with the user output device, wherein the search result includes an indication of an amount of the items from the database that satisfy both the first and second search terms.

In another embodiment the invention provides an apparatus for searching a database, the apparatus comprising a processor coupled to a user input device and a user output device; a machine-readable medium including instructions for execution by the processor, the machine-readable medium including: one or more instructions for accepting first and second search terms from the user input device, wherein the second term is associated with a predetermined list of two or more names; one or more instructions for identifying documents from the database that satisfy the first search term; one or more instructions for determining the frequency of occurrence of the two or more names in the identified documents; and one or more instructions for presenting at least a portion of the identified documents to a user by using the output device, wherein the presented identified documents are ordered according to the determined frequency of occurrence of the two or more names.

In another embodiment the invention provides a method for searching a database having items, the method executing in a system including a user input device and a user output device, the method comprising accepting first and second search terms from the user input device, wherein two or more associated terms are associated with the second search term; and indicating a search result with the user output device, wherein the search result includes an indication of an amount of the items from the database that satisfy both the first search term and the associated search terms.

In another embodiment the invention provides a method for performing a search of an originating database search, the method comprising accepting first and second search terms, wherein the second search term includes associated search terms; using the first search term to obtain first search results from an originating database; and using the associated terms to perform a search of the first search results to obtain second search results.

In another embodiment the invention provides a method for performing a search of a database, the method comprising accepting first and second search terms from a user input device, wherein two or more associated terms are associated with the second search term; using the first search term to obtain first search results from an originating database; using the associated terms to perform a search of the first search results to obtain second search results; and indicating a search result with a user output device, wherein the search result includes an indication of an amount of the items from the database that satisfy both the first search term and the associated search terms.

In another embodiment the invention provides a method for performing a search of an originating database, the method comprising accepting signals at a first processor to create a context definition, wherein the context definition includes one or more associated terms; associating a context definition name with the context definition; sending the context definition to a second processor for selection by a user in a database search, whereby the one or more associated terms are used in connection with a user search term to perform a search of the originating database.

### BRIEF DESCRIPTION OF THE DRAWINGS

FIG. 1 illustrates a screen portion from a user interface according to a preferred embodiment of the invention;

FIG. 2 shows search results of a search requested in FIG. 1.

FIG. 3 shows a screen display where a user is presented with the underlying documents of the hits in FIG. 2;

FIG. 4 shows basic steps in a process for performing a context search;

FIG. 5 illustrates a flow of processing in a preferred embodiment of the invention; and

FIG. 6 illustrates distribution of processing in different applications.

### DETAILED DESCRIPTION OF THE INVENTION

Different embodiments of the invention illustrating preferred implementations of three different applications are described in detail in computer instructions included in the Source Code Appendix of this application. These applications are merely examples. Many other types of applications are possible using features or other characteristics presented herein. The Source Code Appendix should be consulted for implementation details of the subject matter discussed herein.

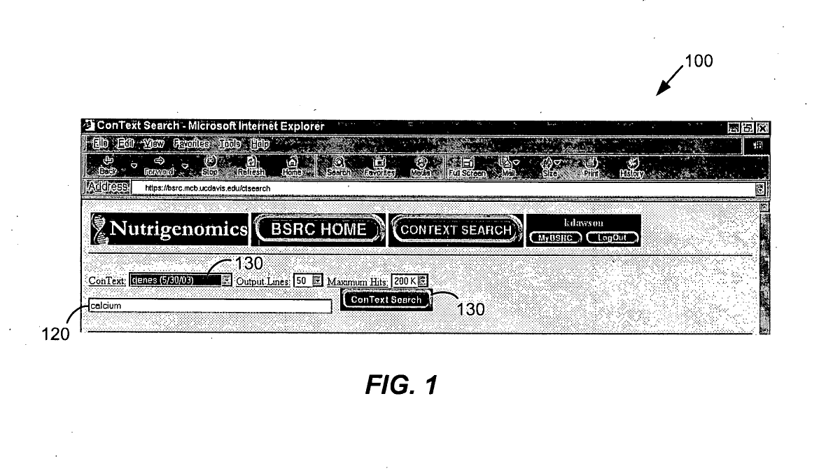

FIG. 1 illustrates screen portion 100 from a user interface according to a preferred embodiment of the invention. In FIG. 1, a user can select a context for a search using the drop-down selector at 110. As shown in FIG. 1, the user has selected the context named “genes” that was created or updated on May 30, 2003. In a preferred embodiment, contexts are authored or defined by a human expert or curator who is aware of the types of searches in which a specific user base is interested. The curator will typically be familiar with the types of databases and types of searches in which the context will be applied. In the example of FIG. 1, the selected context is used for searching a medical research database, such as www.pubmed.com , when a user desires information relating to the general category or context of genes.

The user enters a search term or other search criteria (e.g., additional keywords or terms, relational expressions, conditions, operators, etc.) in the text box at 120. In FIG. 1, the user has entered a single-word term, or keyword, “calcium” as the search criteria. In this example, the user desires to obtain information about genes that play a role in a biological process involving calcium, such as calcium metabolism, calcium signaling, etc. The user can also specify some aspects of the search results that will be presented, such as limiting the number of output lines per page and limiting the maximum number of items that satisfy the search criteria within the context (i.e., “hits”). The user presses context search button 130 to initiate the search.

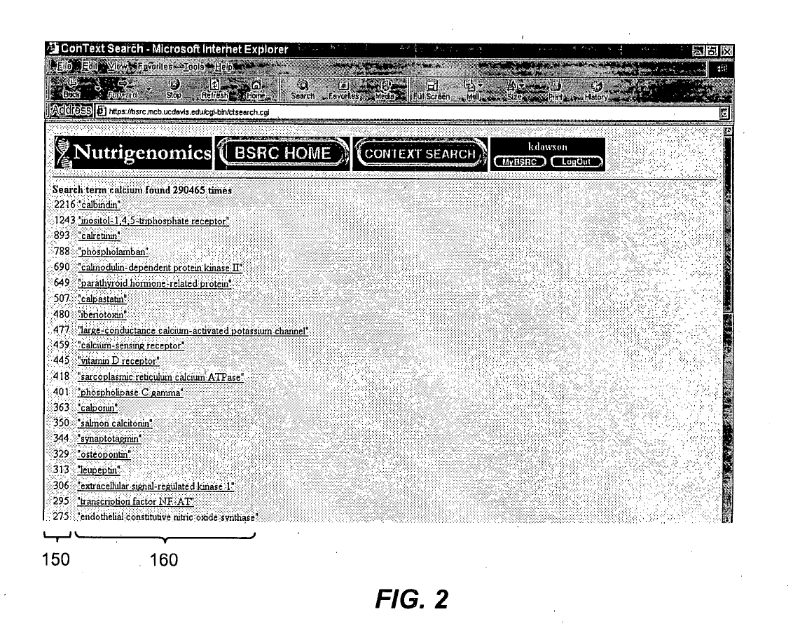

FIG. 2 shows search results of the search requested in FIG. 1.

In FIG. 2, gene names are listed separately in a column at 160. For example, the topmost gene name is “calbindin” followed by “inositol-1,4,5-triphosphate receptor,” “calretinin,” etc. Numbers in a column at 150 appear to the left of each gene name. For each gene, the adjacent “hit” value indicates the number of documents in which the search term “calcium” was found co-occurring with the associated gene name. For example, “calcium” co-occurred in 2216 documents with the gene name “calbindin.”

In a preferred embodiment, the list of gene names associated with the context “genes” is ordered vertically with the gene names having the largest hits at the top of the list. In other words, the context term “genes” is expanded to show its associated terms, the individual gene names, ranked in order according to the search criteria, “calcium.” By viewing the search results in the format shown in FIG. 2, the user is given an overview of the gene names that are most often discussed in the medical research literature in connection with “calcium.” The user is able to achieve this result by using the context term, “genes,” that was recently predefined by a curator so that the user gains the benefit of the curator's knowledge of the database and published research paper format, and the curator's selection and formatting of gene names.

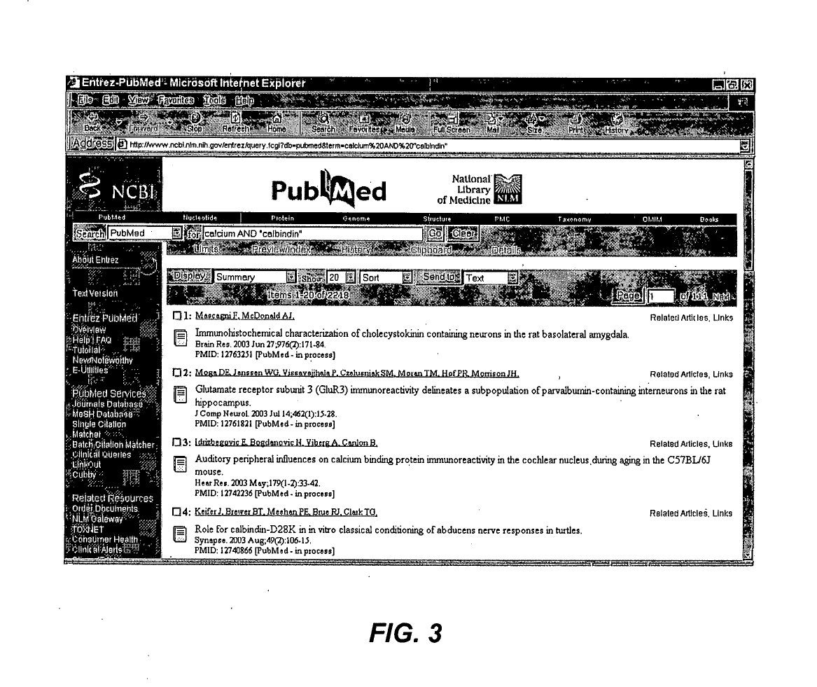

FIG. 3 shows a screen display where a user is presented with the underlying documents of the hits in FIG. 2.

A user can arrive at the display of FIG. 3 by, for example, clicking on a gene name in the listing of FIG. 2. In the case of FIG. 3, a user has clicked on the gene name “calbindin” in the list of FIG. 2. A preferred embodiment of the invention then provides the user with a summary of all of the documents counted as hits in the ranking of calbindin in the list of FIG. 2. The discrepancy in the number of hits (2216 in FIG. 2 vs. 2218 in FIG. 3) is due to additional documents with “calbindin” and “calcium” being added to the PubMed database since the context database records were compiled. This is described in more detail, below.

The documents can be obtained in their entirety from the web page displayed in FIG. 3 by clicking on the document links, or by marking a checkbox next to the document citations, or by other means. Note that other embodiments can deviate substantially from the user interfaces shown. Any manner of obtaining a user's selection of a context and search term can be employed. The format of output results can similarly vary according to desires or needs of a particular embodiment. For example, in other embodiments the user interface need not be based on web pages and Hyper-Text Markup Language (HTML). In general, any suitable user interface design can be used with the invention.

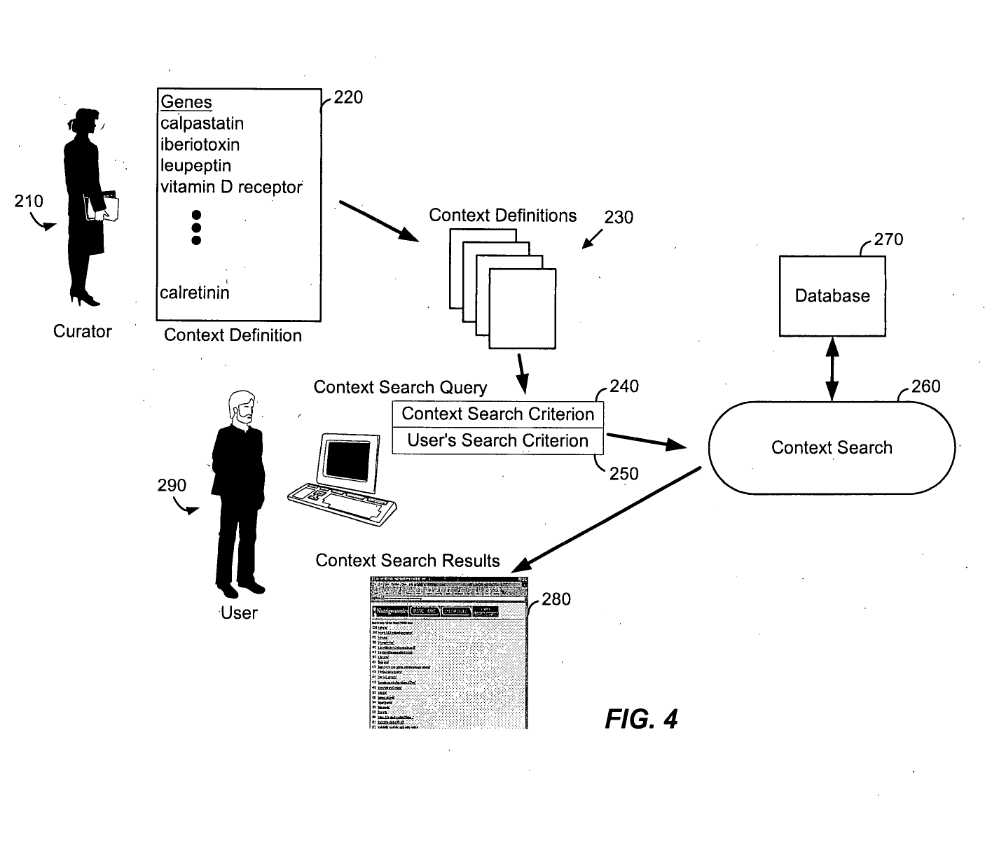

FIG. 4 shows basic steps in a process for performing a context search.

In FIG. 4, curator 210 creates context definition 220. In the present examples, the field of genetic research is used and a sample definition is the category of “genes”. The context definition includes a list of individual gene names that the curator decides will be appropriate and useful to a typical user performing a search on database 270. In other applications, the curator need not have knowledge of the database, user or types of likely searches. However, the more knowledge that the curator has of the specific field, database, user, user searches, etc., the more accurate and useful will be the curator's context definition.

A context definition can be more than merely a list of names. For example, in a preferred embodiment, the list of gene names to be used in a “genes” context search of the PubMed database uses Medical Subject Header (MeSH) searching. MeSH is the National Library of Medicine's controlled vocabulary thesaurus and includes sets of terms naming descriptors in a hierarchical structure that permits retrieval of documents that may use terminology, such as a gene name, in a different format but intending the same gene (see, e.g., www.nlm.nih.gov/mesh).

A curator who is aware of utilities, operators or other features of a database or database service for which the context definition is being created can take advantage of the features in designing the context definition. So, for example, the “genes” context can invoke MeSH functionality. Other examples, include using search query language functions (e.g., SQL), relational or other operators, specifying searching to occur in different sections, segments or other portions of database documents or items, programming routines or other functionality into a context definition, or using other devices or search syntax in a context definition.

The curator can use software or hardware utilities to create context definitions. For example, a list of gene names can be obtained from a previously compiled list. The list can be created by a series of database searches, or by using robots or spiders to automatically search through database items, web pages, etc. In some applications the creation of context definitions can be automated in whole or in part. Similarly, updating of a context definition (e.g., when the known list of gene names changes) can be performed manually or automatically. In general, context definitions can be created using manual or automated methods and combinations of manual and automatic approaches including any number of human curators, software processes or hardware devices.

Typically, curators will create a set of context definitions such as context definition set 230. The entire set of context definitions can be transferred to a user site such as user 290. The context definitions can reside local to a user's computer system or can be stored remotely from the user's system as where the definitions are maintained at a curator site, or other site, and are accessible via a digital network such as a LAN or the Internet. In general, any functions, data storage, transfer operations or other processing described herein can be performed at any physical location or locations, by any number of processors or processes.

Context definitions 230 are provided to a user, or user system, shown at 290. In a preferred embodiment, the use of a context definition in a search is optional. The user creates a traditional search by supplying a search term or criterion and can place the search into a context by selecting a context name from a menu of available contexts as described above in connection with FIG. 1. Naturally, other approaches can be used to supply a context. For example, a context can be set to a default value so that it is always active. Another approach monitors a user's searches. If the monitored search is detected to return a large number of hits (e.g., over 1000) the user interface can suggest that the user try a context search.

It is anticipated that the number and type of context definitions can grow to a large number. Context definitions can have attributes such as the name of the company, curator, or other controlling entity that authored the context definition. The target database type, field of use, specialty area, etc., can also be included as an attribute to the context definition. Additional possible attributes include the time of creation of the context definition, time of last update, short description of the context definition, rating of performance of searches using the context definition (e.g., user satisfaction, number of average hits, time to execute, etc.) can be included. Additional attributes or properties of a context definition can be included. A context definition library can be searched using the attributes in much the same manner as other database items (e.g., documents, files, objects or other data). The context definition library can, in turn, be searched using context searching to assist a user or facility manager to obtain desired context definition sets.

Context definition sets can be sold, licensed, or be part of another revenue scheme. For example, a user or facility can subscribe to a context creation service whereby the context definitions provided by the service are automatically updated and new contexts can be provided on a monthly basis. A charge for context searches can be based on use (e.g., per search), number of users, number of sites, time period, etc. Context definition sets, or individual context definitions can be distributed, marketed or otherwise provided by any means such as those commonly used for software or data. For example, shareware, click-wrap licensing, viral marketing/distribution, etc., can all be employed. In general, context definitions can benefit from any of use, distribution revenue generation or other properties of digital information in commerce.

Users can modify a predefined (i.e., curator-defined) context definition to create derivative context definitions. For example, a user group that receives a comprehensive list of genes for the “genes” context definition may desire to focus the list on certain types of genes by editing the curator-defined “genes” context definition to remove some gene names. The context definition format can be in a form so that it is editable by standard word-processing applications, or other applications. The user modified context definitions can be renamed or otherwise identified so that confusion with the original context definition is avoided. Tools, or authoring utilities can be provided to users for specialized editing or creation of context definitions.

In some applications it may be desirable to restrict use and modification of context definitions. In such cases, security measures such as using access rights regulation, encryption, or other approaches can be employed. One way to ensure protection of context definitions is to ensure that access and use of a context definition does not take place at a user, or client, site. This approach is discussed in more detail, below.

Multiple contexts can be used. For example, where first and second context definitions include lists of names, then specifying both contexts along with a user criterion could result in performing the context search similar to that of a single context definition that only includes the intersection of the lists of names of both the first and second context definitions. Another approach is to use multiple context definitions to retrieve and present search results in a multidimensional format. For example, the 300,000 documents found with the search term “calcium” may be sorted in the context of genes. This sorted result can then be sorted again in another context, e.g., dietary terms, which would allow for a fast and more granular understanding of gene-diet interactions in calcium metabolism and signaling. Multidimensional context sorting can be presented in, e.g., the form of a table, three dimensional chart or graph, virtual reality object, or by other means.

In FIG. 4, a context search query includes both a context search criterion and a user search criterion. The context search criterion, or term, includes a selection of a context definition. Typically, each context definition will be associated with a descriptive name or phrase that is designated in a search window. A user search criterion or term can include any traditional database query approaches.

The context search query is submitted to context search server 260 and is typically directed at a known originating database such as database 270. The originating database stores the target documents or other database items that are the subject of the query. Context search server 260 uses both the context and user search criteria to query originating database 270 (and/or other databases) and also can use pre-compiled search results from the databases. The preferred variations and approaches of context database server processing are discussed in more detail, below.

Results of the context search are returned to the user as context search results 280. Although an ordered list format is primarily discussed in this application, any manner of search result presentation can be used with differing advantages depending upon specific embodiments. For example, chart, diagram or other pictorial presentations can be used to display results. Multidimensional results can be presented. The results, themselves, can be formed into records -for subsequent searching and can also be used as the basis to make new context definitions.

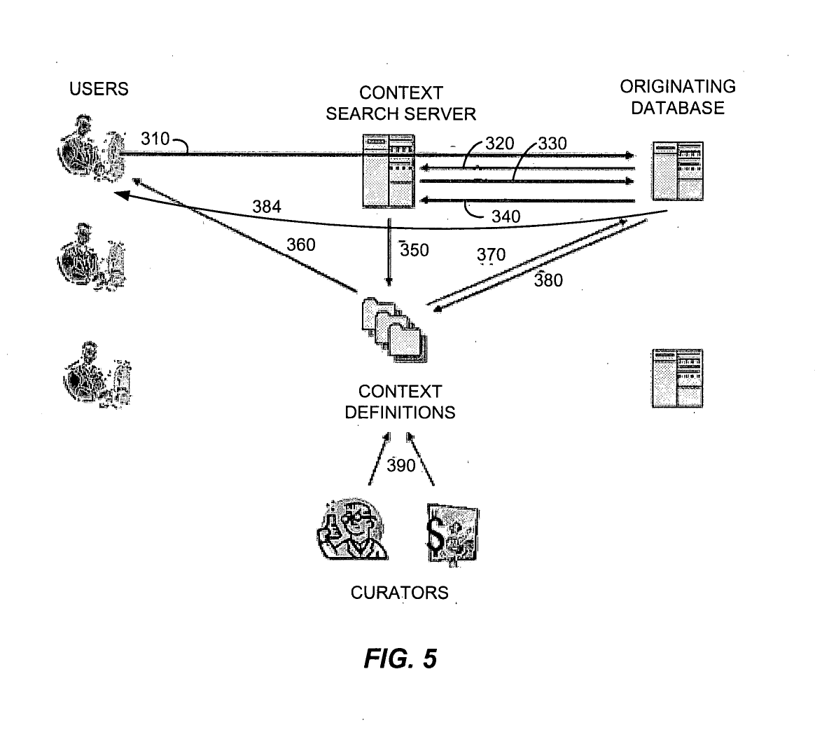

FIG. 5 illustrates a flow of processing in a preferred embodiment of the invention. Users access an originating database via a context search server. At some time prior to the user's search, the context search server compiles independent search results based on context definitions that will be available to the user and which the user might invoke. For example, in the case of the “genes” context, the preferred embodiment performs a search in the originating database for each of the gene names and stores the resulting hits of document unique identifiers returned for each gene name.

A user enters a context search query including a user search term and a context search term into a form provider by the contextual search server's website. At 310 the context search server forwards the user's search term to the originating database search engine. The originating database search engine performs the search using the user search term and sends an identification of the number of found documents back to the contextual search server at 320. At 330 the contextual search server requests the unique identifiers of the returned documents from the user search term query and these are provided by the originating database to the context search server at 340.

Assuming the “genes” context is selected, the user search term results are compared to each of the pre-compiled lists of document identifiers for each individual gene name associated with the “genes” context definition. The results of the comparison are then formatted as an HTML document and sent back to the user at 360. The user can select a specific document or documents identified from the results and the document is retrieved from the originating database at 384. The context databases are regularly updated with the changes in the literature databases as indicated at 370 and 380. The search terms in the context databases are created and/or updated manually or automatically by human curators or processes or devices as indicated at 390.

Note that other processing configurations are possible in other embodiments. For example, rather than pre-compiling lists of results from the originating database, the context server can send successive searches with elements of an expanded context definition (in this example, the gene names) to the originating server so that the originating server performs the operation of determining co-occurrences in documents of the user's search term and an element (e.g., gene name), of the context term. However, in the example case of a current list of 40,000 gene names this would require 40,000 separate Boolean queries of the originating database, and would be prohibitive in terms of time and loading of the originating database server.

In other applications where the number of context term elements is small, or the context search criterion does not impose a large processing burden, the method of having the originating database server perform context-based searching on demand may be appropriate. Yet another processing variation is to perform the context term queries first and compare those results with user term queries. In general, any manner or type of processing can be used to provide context-based searching according to the present invention.

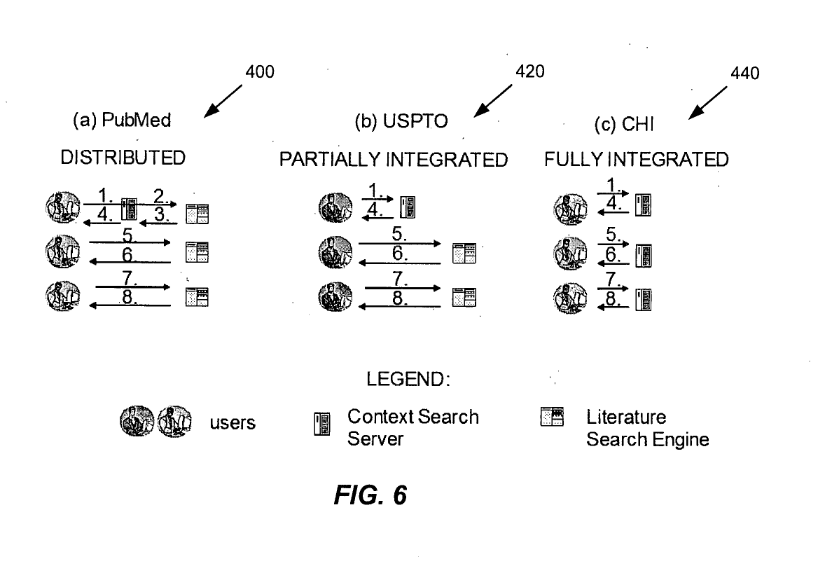

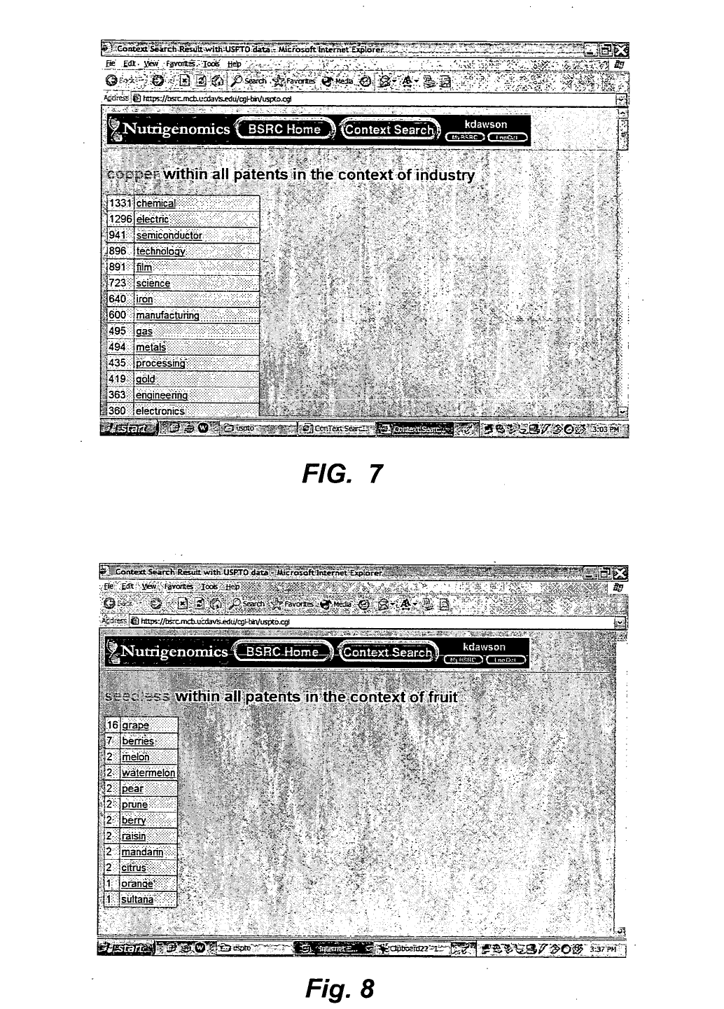

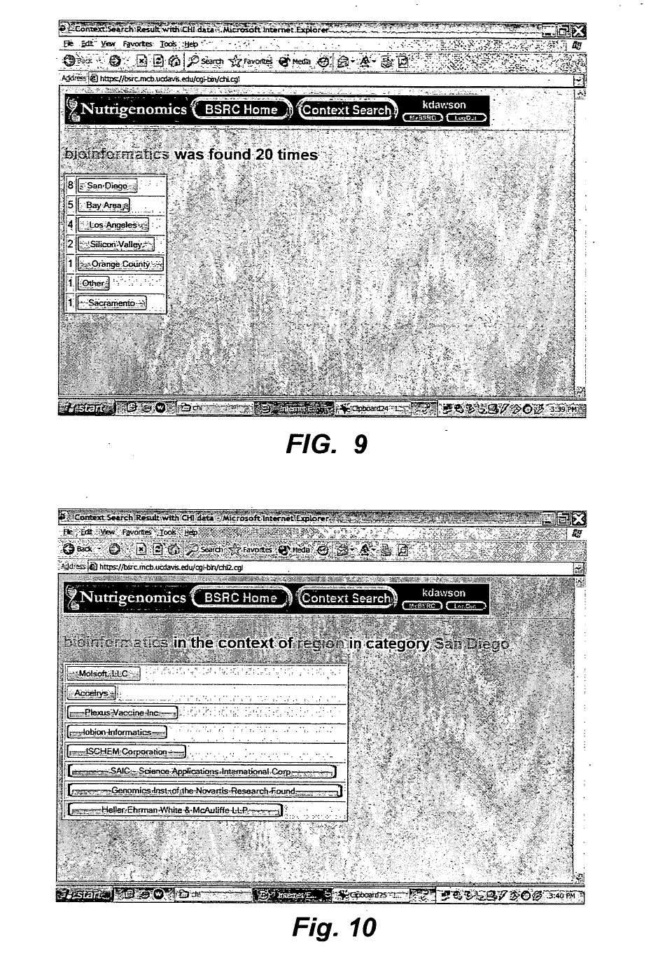

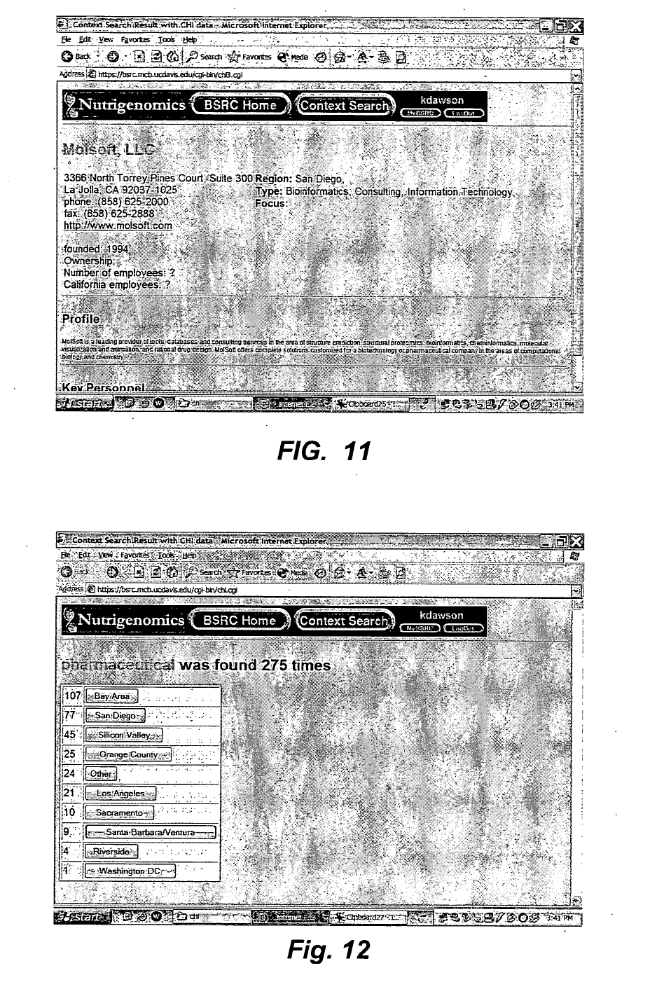

FIG. 6 illustrates distribution of processing in different applications.

In FIG. 6, distributed system 400, partially integrated system 420 and fully integrated system 440 are each complete implementations of embodiments of a context search system. These approaches were used in test systems where the originating databases were PubMed, U.S. Patent and Trademark Office (USPTO) and California Healthcare Institute (CHI) databases, respectively. In each approach, user input can be obtained for three different selections as follows: first when the user enters the search term and selects a context database (1), second when the user selects a context-specific term (5), and third, when the user retrieves a particular document (7).

The context-specific rendering of search results can be carried out by the Context Search server (4). The literature search job may be forwarded to another system, referred to as an originating database or system. Distributed system 400 shows an example where the literature search is forwarded to an originating server at steps 2 and 3. The literature search can also be carried out in the context search server if the literature database is hosted locally, as shown in partially integrated system 420 and fully integrated system 440 at step 4. The search with a Boolean combination of the user's term and a selected context-specific term can be done either by the literature search engine: (as in 400 and 420 at step 6) or in the Context Search server (system 440 at step 6). The documents can be retrieved from the original literature database (400 and 420 at step 8) or from a local copy: (440 at step 8). Other applications can use any suitable arrangement of processing allocation and can use additional or different processors, processing and/or databases.

An embodiment of the invention was designed for context searching of the U.S. Patent and Trademark Office patent database. Patent documents from 2001 through the present were accessed at the USPTO File Transfer Protocol (FTP) server and downloaded to a local computer. Patent data were parsed into a MySQL database table. This patent table included fields for all text information in the patent and other specific fields for the patent number, date of issue, assignee's city, state, and country. Search speed was improved by indexing of the data and tuning of the database engine (e.g., setting variables for key buffer size, maximal binary log cache size, maximal binary log size, maximal join size, etc., as desired). Several context databases were also pre-compiled and stored in other database tables. These context databases included those shown in Table I, below.

TABLE I
Industries: Our goal with this context database is to find the user-entered
term in patents and explain, from which industries those patents were
published.
U.S. assignee's state: A geographic context for mapping patents with
the user-entered term on the U.S. map.
Assignee's country: Another geographic context for mapping patents
with the user-entered term on the globe.
State names: Unlike the context of U.S. assignee's state, this context
looks for state names anywhere in the patent description. A search in
this context can reveal the geographic distribution of patents with the
user-entered term even when the patents are pertaining to certain
geographic regions for reasons other than just the assignee's location.
Financial terms: This context database is useful for searches when the
user wants to find economy- and finance-related inventions and their
relevance to the user-entered term.
Business terms: Although similar to the financial terms context, this
context database describes the field of business and management.
Fruits: A context database with several fruit names is useful for searches
in the field of food and beverage industry and agriculture. This context
database can be especially practical when the user searches his or
her term in plant patents.

The USPTO embodiment uses context-based searching as discussed above in the PubMed embodiment using the PubMed database. However, in the USPTO embodiment both the literature database and context database are performed in a single system.

A third embodiment of the invention uses data from the California Healthcare Institute (CHI) database including almost three thousand entries of California companies and organizations active in the medical, pharmaceutical, medical device, and biotechnology industries. The data were accessed at the CHI website and parsed into a MySQL database. CHI database-related contexts were created to search existing annotations in the CHI (originating) database entries including geographical regions within California, disease focus and organizational type.

In the CHI embodiment the originating database and the context databases were all hosted in the same computer and both the primary and context searches sere performed by the same MYSQL database management system.

Thus, the three embodiments use different variations of integrating or distributing functions into one or more computer systems. In all the three implementations, the user can interact with the context server and can enter a user search term into a form provided by a context search web server. In the case of the PubMed embodiment, the user's term is forwarded to a third party hosting the PubMed database and the literature search is carried out by the third-party's search engine. In the case of USPTO or CHI embodiments, the USPTO data and CHI data are locally stored in a MySQL database in the context search server and the literature searches are carried out locally.

In all three cases, the context databases are hosted locally and the context-specific rendering of results is carried out by the context search server. The context-specific result is formatted as a web page and returned to the user. The results page includes links to Boolean searches of the user's term and the context-specific terms. In the case of PubMed and USPTO data, these Boolean searches are carried out and the documents are retrieved by the third party search engines. On the other hand, in the case of CHI data, these searches are done locally by the context search server. Note that other variations are possible that will be within the scope of the invention.

Table II summarizes results of different types of context searches in the USPTO and CHI embodiments using context definitions of the type described in Table I.

TABLE II

| Entry | Database | User Term | Context Term | Results Summary |
|---|---|---|---|---|
| 1 | USPTO | Copper | Industries | Chemical, electric, semiconductor, technology, film, |
| | | | | science, . . . |
| 2 | USPTO | Automobile | Industries | Electric, automotive, gas, technology, sport, tire, rubber, |
| | | | | plastic, . . . |
| 3 | USPTO | Context | Industries | Computer, processing, technology, communication, |
| | | | | network, . . . |
| 4 | USPTO | Coal mining | Industries | Coal, mining, technology, engineering, electric, drilling, |
| | | | | energy, gas, . . . |
| 5 | USPTO | Database | Industries | Computer, science, network, communication, technology, |
| | | | | . . . |
| 6 | USPTO | Flat tire | Industries | Tire, rubber, construction, gas, plastic, manufacturing, |
| | | | | steel, . . . |
| 7 | USPTO | Paper mill | Industries | Paper, chemical, science, film, industrial, processing, |
| | | | | printing, . . . |
| 8 | USPTO | Petroleum | Industries | Oil, gas, technology, chemical, engineering, science, |
| | | | | energy, . . . |
| 9 | USPTO | Automobile | Assignee's | Michigan, California, Ohio, New York, Illinois, New |
| | | | state | Jersey, Florida, . . . |
| 10 | USPTO | Biotechnology | Assignee's | California, Massachusetts, New York, New Jersey, |
| | | | state | Pennsylvania, . . . |
| 11 | USPTO | Soybean | Assignee's | lowa, California, Illinois, New Jersey, Ohio, |
| | | | state | Massachusetts, . . . |
| 12 | USPTO | Tomato | Assignee's | California, lowa, Illinois, New York, Massachusetts, |
| | | | state | Delaware, . . . |
| 13 | USPTO | Corn | State | lowa, New York, Wisconsin, Washington, Connecticut,.. |
| 14 | USPTO | Intellectual | State | New York (many publishers), Washington, |
| | | property | | Massachusetts, California, . . . |
| 15 | USPTO | Computer | Country | US, Japan, Germany, Taiwan, Canada, Korea, . . . |
| 16 | USPTO | Plastic | Country | US, Japan, Germany, France, Canada, Taiwan, UK, . . . |
| 17 | USPTO | Business plan | Business | Business plan, accounting, planning, . . . |
| 18 | USPTO | Human | Business | Human resources, small business, electronic commerce, |
| | | resources | | . . . |
| 19 | USPTO | Time | Business | Time management, planning, telecommunication, . . . |
| | | management | | |
| 20 | USPTO | ATM | Finance | ATM, currency, debit, smart card, debit card, credit card, . . . |
| 21 | USPTO | Credit card | Finance | Credit card, debit, smart card, debit card, . . . |
| 22 | USPTO | Antioxidant | Fruit | Olive, grape, berry, . . . |
| 23 | USPTO | Juice | Fruit | Orange, apple, grape, citrus, berry, lime, lemon, . . . |
| 24 | USPTO | Seedless | Fruit | Grape, berries, melon, watermelon, . . . |
| 25 | CHI | Bioinformatics | Regions | San Diego, Bay Area, Los Angeles, Silicon Valley, . . . |
| 26 | CHI | Bioinformatics | Region: San | Molsoft, LLC; Accelrys; Plexus Vaccine, Inc.; Iobion |
| | | | Diego | Informatics; ISCHEM Corp., . . . |
| 27 | CHI | Bioinformatics | Region: San | Molsoft, LLC —specific company information |
| | | | Diego | |
| 28 | CHI | Pharmaceutical | Regions | Bay Area, San Diego, Silicon Valley, Orange County, . . . |
| 29 | CHI | Pharmaceutical | Region: Bay | Dow Pharmaceutical Sciences, ChemGenex |
| | | | Area | Therapeutics, Inc.; Questcor Pharmaceuticals, Inc.; . . . |
| 30 | CHI | Pharmaceutical | Region: Bay | Dow Pharmaceutical Sciences —specific company |
| | | | Area | information |
| 31 | CHI | AIDS | Disease focus | HIV/AIDS, HCV, infectious disease, cancer, immune |
| | | | | disorder, . . . |
| 32 | CHI | Pharmaceutical | Disease focus | Cancer, cardiovascular, diabetes, infectious disease, . . . |
| 33 | CHI | AIDS | Company type | Medical device, non-profit, pharmaceutical, biotech, |
| | | | | university, . . . |
| 34 | CHI | Consulting | Company type | Consulting, bioinformatics, information technology, . . . |
| 35 | CHI | Plastic | Company type | Medical device, contract manufacturer, supplier, . . . |

In Table II, each row, or entry, describes a context search and provides a summary of results of the search. Typically the results are displayed on a computer display screen as a vertical list ordered according to the number of hits for each context associated name and the user term. However, for compactness only partial results are shown in horizontal table form with the number of hits omitted.

For example, entry 1 shows that a user term of “copper” in the context of “industries” performed using the USPTO database returns a list of industry types, e.g., “chemical,” “electrical,” “semiconductor,” . . . Presumably this list shows that the chemical industry is doing the most innovative work with the material copper. This inference can be made since the user knows that the USPTO database contains published and issued patents. A curator who creates the context definition for “industry” associates each of the known classifications (possibly including terms, rules, algorithms, etc.) of industry that are used by the USPTO database. For example, the USPTO database includes a field, or attribute, with each patent that classifies the patent according to broad subject matter. The classification names used by the USPTO are each associated with the context definition of “industry” and the associated names are used to perform the context searching in the classification field of each document returned from a query of the user term according to the present invention.

In a preferred embodiment, the context definition “industry” was created in a way that many terms were determined that convey the meaning of certain types of industries. This list of terms can already be used in Context Search. However, in an expertly curated version of this context database, the domain expert can establish not only the list of context definitions but also the rules of document annotation with those terms. For example, “radio” is a type of industry and is part of the context definition “industry”. However, in addition to this meaning, the lexical term “radio” may also refer to other concepts such as a radio receiver or part of words related to electromagnetic radiation, etc. A context definition can be sensitive to these distinctions and can define concepts rather than lexical terms. This distinction can be made in the way that the curator establishes the list of context terms and the rules of document annotation using these terms.

Alternative ways to design the context definition for “industry” are possible. For example, where a third-party database operator does not provide a list of names in a category such as “industry” to further define the category, “industry,” the curator can select and associate a list of names from a different database, tool, utility, or manually by knowledge or selection, or by other means. If no “industry” attribute is included with documents in a database then the names associated with “industry” can be searched in any selected field, section or other characteristic or property of a document. For example, the names “chemical,” “electric,” “semiconductor,” etc., can be searched in the Abstract, Summary or other sections of patents in the database.

A curator can use any other approaches to defining a context such as “industry.” For example, patents have “art unit” or “group” classifications where patents are classified by technology and are sent to a group of examiners who specialize in the technology. The art unit's are identified by an ID number that appears in the patent document. The ID number can be looked up in a directory maintained by the USPTO at its web site. The ID number can thus provide a description of the art unit. The art unit descriptions can be used to define contexts. Or the art unit descriptions and names can be used to match to industry types such as “chemical,” “electric,” “semiconductor,” etc.

FIG. 7 shows a screen image of the results from performing a search along the lines of entry 1 in Table II. In FIG. 7, the names associated with the context definition of “industry” are ranked according to the number of returned hits, or documents, that satisfy both the user term and the context term. As shown in FIG. 7, “chemical” is associated with 1331 patents or patent publications. “Electric” is associated with 1296 hits, “semiconductor” with 941 hits, and so on. From this information a user can quickly determine the type of industries that are involved with copper. This information may lead a copper mining company to direct its sales efforts to a particular industry, or to better be able to predict trends, industry requirements, etc. The user can scroll down, go to the next page, or otherwise view the remainder of industry types and their rankings.

In a preferred embodiment, clicking on an industry type name (e.g., “chemical”) links the user to a page that lists documents that contribute to the hit count. Many other types of linking are possible. For example, the user can be provided with a link that explains the functioning or definition of the context more fully. For example, the associated name “chemical” can, in turn, have associated names such as the names of chemicals. Clicking on chemical (or another link) can take the user to an expanded results presentation where the 1331 hits for “chemical” are further ranked according to the chemical names associated with “chemical.” Many variations using such “nested” context definitions are possible.

Returning to Table II, entries 2-8 each use a different user term in the context of “industries” with the USPTO database. For example, the results for entry 2 ostensibly show the industries doing the most research and development with automobiles. Similarly, entry 3 ranks industries where the term “context” is used in the patent.

Entries 9-12 use a context definition of “Assignee's state.” The assignee state indicates the state in which a patent owner resides. Thus, the context of “assignee's state” can be useful to determine where control of technology resides within the U.S. For example, the results for entry 9 can be read to show that ownership of patents regarding automobiles are most popular in Michigan, California, Ohio, New York, etc., in that order. Of equal importance may be the states at the bottom of the list (not shown) where it is implied that those states at the bottom do not deal as much with automobile innovation or industry. These observations can be useful, for example, in deciding which laws to pass, determining how the national economy is functioning, predicting effects of automobile imports on statewide jobs, etc. Many types of queries and conclusions can be drawn with the aid of context searching.

Entries 13 and 14 use a slightly different context of “state.” The “state” context is designed to search for matches with state names anywhere in the patent description. A search in this context can reveal the geographic distribution of patents with the user-entered term even when the patents are pertaining to certain geographic regions for reasons other than just the assignee's location (which is a separate attribute and record maintained by the USPTO in association with each patent).

Similarly, entries 15 and 16 are directed to a country context where different country names are associated with the context term. Entries 17-19 use a business context definition having associated names of business types, e.g., Human resources, electronic commerce, etc. Entries 20-21 use a “finance” context and entries 22-24 use a “fruit” context. An example of the results of the entry 24 query is shown in FIG. 8. A user might conclude that most of the effort to create seedless fruit is directed to grapes.

Entries 25-35 use the California Healthcare Institute (CHI) database. This database is known to both curator and user to include published research papers from companies and institutions in California. Entry 25 is a search designed to determine the areas of California that are doing the most research in bioinformatics. A curator has defined the context “regions” to be associated with locally familiar region names such as “Bay Area,” “San Diego,” “Los Angeles,” “Silicon Valley,” etc. Entry 25 shows that the ranking for bioinformatics documents in CHI is “San Diego,” “Bay Area,” “Los Angeles,” etc. This ranking is shown in a screen display at FIG. 9. Note that a possible name associated with the context can include a default, or miscellaneous category such as “other.” In this case, any region that is not covered by the associated names can be included in the “other” region.

In FIG. 9, the results page allows the user to obtain more detailed information. For example, the user can click on any of the region names and be provided with a breakdown of companies in that region area.

FIG. 10 shows the result of a user selecting the “San Diego” region of FIG. 9. In FIG. 10, company names associated with the San Diego region are listed. These company names can be ordered according to document hits, if desired. The company names are obtained from fields in the CHI database that are used to identify addresses or locations of a company or institution that contributes a paper to be included in the CHI database. Local records were pre-compiled at the context server by parsing web pages at the CHI website to obtain information on geographic region names, and companies. The manner of pre-compiling, and amount and type of information that is pre-compiled will vary with different embodiments. The listing of FIG. 10 corresponds with entry 26 of Table II. The user can select a specific company from the list in FIG. 10.

FIG. 11 shows the display after a user selects the company “Molsoft, LLC” from the display of FIG. 10. In FIG. 11, details of the selected company are displayed. FIG. 11 corresponds to entry 27 in Table II.

FIG. 12 and Table II entries 28-30 show a search with user term “pharmaceutical” in the region context, similar to the search of “bioinformatics” of entries 25-27. Entries 31-32 illustrate searches designed to show what types of diseases are studied in relation to AIDS and pharmaceutics, respectively. Entries 33-35 use a “company type” context to illustrate the types of companies that are performing research concerning healthcare in “AIDS,” “consulting” and “plastic,” respectively.

Context-specific rendering of search results can help facilitate business decisions when the decision maker wants to have an understanding of a phenomenon without expert technical knowledge of a certain field. Context-specific rendering of search results carried out in the context of genes may help the decision maker to find out the genes that are important in a certain phenomenon without knowing the names of the genes beforehand. After the context-specific rendering of search results, the business executive may decide which expert to consult to have an expert understanding of the role of genes most commonly co-occurring with his search term in the scientific literature.

Biomedical scientific literature searches are not the only field where context-specific rendering of search results may be useful. Any information retrieval system may benefit from this new method. For example, a catalog of music compositions may be searched with key words; and the search result can then be rendered in the context of composers, styles, genres, eras, countries, music instruments used in the piece, etc. In this example, context-specific rendering of search results will answer the type of questions such as “What was the Viennese Classicals' favorite genre?” without necessitating the user to look at all the thousand entries found with the search term “Viennese Classical”. Another example is library catalogs, the Library of Congress, or other document catalogue systems. Using the current search services, it is easy to find out who authored the novel entitled “War and Peace”. On the other hand, we need context-specific rendering of search results to know the answer to the question “Authors of which country wrote most of the novels about war and peace?” Electronic catalogs about paintings, movies, news photographs, other media items, customers, employees, products, parts, websites, registered vehicles, resumes, government publications, bills, drugs, chemicals, gene expression data, etc., all may benefit from context-specific rendering of search results. In any case when the user wants to organize a search output in one particular context, context-specific rendering of search results may be the best approach.

Although the invention has been described with respect to particular embodiments thereof, these embodiments are merely illustrative and not restrictive of the invention. For example, although the invention has been presented in connection with specific database applications (medical research, patent research and healthcare) it should be apparent that any conceivable database application can benefit from features of the present invention.

A “term” or “search term” can include any condition, operator, symbol, name, phrase, keyword, meta-character (e.g., a “wild card” character), function call, utility, database language construct or other mechanism used to facilitate a search of data. It should be apparent that many traditional techniques used in database query and results presentation can be used to advantage with features of the present invention. Search terms need not be limited to a single text input but can include multiple lines of functional text or other information.

In some embodiments not all of the steps disclosed herein need be used. Many such variations will be apparent to one of skill in the art.

Note that although specific means of user input and output are presented, any suitable input or output devices or approaches can be suitable for use with the present invention. For example, any number and type of text boxes, menus, selection buttons, or other controls can be used in any arrangement produced by any suitable display device. User input devices can include a keyboard, mouse, trackball, touchpad, data glove, etc. Display devices can include electronic displays, printed or other hardcopy or physical output, etc. Although the user interfaces of the present invention have been presented primarily as web pages, any other format, design or approach can be used. User input and output can also include other forms such as three-dimensional representations and/or audio. For example, voice recognition and voice synthesis can be used. In general, any input or output device can be employed.

Input to a context search can be automated. For example, a user query and context selection can be achieved with a software application or other process such as the output of an analytic instrument such as laboratory analyzer, gene expression array analyzer, mass spectrometer, isotope spectrometer, etc. For example, these devices may label certain gene names or protein names that can be used either in a search query or to help define a context.

Any suitable programming language can be used to implement the routines of the present invention including C, C++, Java, assembly language, etc. Different programming techniques can be employed such as procedural or object oriented. The routines can execute on a single processing device or multiple processors. The functions of the invention can be implemented in routines that operate in any operating system environment, as standalone processes, in firmware, dedicated circuitry or as a combination of these or any other types of processing.

Steps can be performed in hardware or software, as desired. Note that steps can be added to, taken from or modified from the steps presented in this specification or Figures without deviating from the scope of the invention. In general, descriptions of functional steps, such as in tables or flowcharts, are only used to indicate one possible sequence of basic operations to achieve a finctional aspect of the present invention. Functioning embodiments of the invention may be realized with more or less processing than is described herein.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, personal digital assistant (PDA), cell phone or other hand-held processor, or any of the like. A “computer program” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” or “machine-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. Although the invention is described with respect to a client-server network organization, any network topology or interconnection scheme can be used. For example, peer-to-peer communications can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Any communication channel or connection can be used such as wired, wireless, optical, etc.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

The scope of the invention is to be determined solely by the appended claims.

1. A method for searching a database, the method executing in a system including a
user input device and a user output device, the method comprising accepting first and second search terms from the user input device, wherein the second term is associated with a predetermined list of two or more names;
identifying documents from the database that satisfy the first search term;
determining the frequency of occurrence of the two or more names in the identified documents; and
presenting at least a portion of the identified documents to a user by using the output device, wherein the presented identified documents are ordered according to the determined frequency of occurrence of the two or more names.

2. The method of claim 1, wherein the predetermined list of names is created at least in part by receiving signals from a user interface.

3. The method of claim 1, wherein the predetermined list of names is created at least in part by receiving signals from a process.

4. The method of claim 1, wherein the second term is selected from a list of context names.

5. The method of claim 1, wherein identifying documents includes sending a database query to a database server; and
receiving search results from the database server.

6. The method of claim 5, wherein the search results include document identifiers.

7. The method of claim 1, wherein the first search term includes one or more of a condition, operator, symbol, name, phrase, keyword, wild card.

8. The method of claim 1, wherein determining includes
searching the identified documents to determine if a name is present in a document.

9. The method of claim 8, wherein searching includes
pre-compiling a list of identifiers for documents in which a name occurs; and
comparing the identified documents with documents identified in the pre-compiled list to determine matches.

10. The method of claim 1, wherein presentation of documents includes listing document identifiers on a display screen in decreasing order of the frequency of occurrence of the two or more names.

11. The method of claim 1, wherein indicating a search result further includes
ordering a list of the two or more associated terms according to a frequency of occurrence of the associated terms in the items.

12. The method of claim 1, wherein the user output device includes a display device, the method further comprising
displaying the associated terms along with the number of items in which an associated term occurs.

13. The method of claim 1, further comprising
automatically defining two or more terms associated with the second term.

14. The method of claim 1, further comprising
accepting signals from a user input device to define two or more terms associated with the second term.

15. The method of claim 11, wherein the second term includes the keyword “genes” and wherein an associated term includes a gene name.

16. The method of claim 1, wherein the second term includes the keyword “regions” and wherein an associated term includes a region name.

17. A method for searching a database having items, the method executing in a system including a user input device and a user output device, the method comprising
accepting first and second search terms from the user input device, wherein two or more associated terms are associated with the second search term; and
indicating a search result with the user output device, wherein the search result includes an indication of an amount of the items from the database that satisfy both the first search term and the associated search terms.

18. The method of claim 17, wherein the second search term includes a name.

19. The method of claim 17, wherein the second search term includes a phrase.

20. The method of claim 17, wherein the second search term includes a symbol.

21. The method of claim 17, wherein the second search term includes a rule.

22. The method of claim 17, wherein the second search term includes an operator.

23. The method of claim 17, wherein the second search term includes a function.

24. An apparatus for searching a database, the apparatus comprising
a processor coupled to a user input device and a user output device;
a machine-readable medium including instructions for execution by the processor, the machine-readable medium including:
one or more instructions for accepting first and second search terms from the user input device, wherein the second term is associated with a predetermined list of two or more names;
one or more instructions for identifying documents from the database that satisfy the first search term;
one or more instructions for determining the frequency of occurrence of the two or more names in the identified documents;
one or more instructions for presenting at least a portion of the identified documents to a user by using the output device, wherein the presented identified documents are ordered according to the determined frequency of occurrence of the two or more names.

25. An apparatus for searching a database, the apparatus comprising
a processor coupled to a user input device and a user output device;
means for accepting first and second search terms from the user input device, wherein the second term is associated with a predetermined list of two or more names;
means for identifying documents from the database that satisfy the first search term;
means for determining the frequency of occurrence of the two or more names in the identified documents;
means for presenting at least a portion of the identified documents to a user by using the output device, wherein the presented identified documents are ordered according to the determined frequency of occurrence of the two or more names.

26. A machine-readable medium including instructions executable by a processor for searching a database, the machine-readable medium comprising
one or more instructions for accepting first and second search terms from the user input device, wherein the second term is associated with a predetermined list of two or more names;
one or more instructions for identifying documents from the database that satisfy the first search term;
one or more instructions for determining the frequency of occurrence of the two or more names in the identified documents;
one or more instructions for presenting at least a portion of the identified documents to a user by using the output device, wherein the presented identified documents are ordered according to the determined frequency of occurrence of the two or more names.

27. A method for performing a search of an originating database search, the method comprising
accepting first and second search terms, wherein the second search term includes associated search terms;
using the first search term to obtain first search results from an originating database; and
using the associated terms to perform a search of the first search results to obtain second search results.

28. A method for performing a search of a database, the method comprising
accepting first and second search terms from a user input device, wherein two or more associated terms are associated with the second search term;
using the first search term to obtain first search results from an originating database;
using the associated terms to perform a search of the first search results to obtain second search results; and
indicating a search result with a user output device, wherein the search result includes an indication of an amount of the items from the database that satisfy both the first search term and the associated search terms.

29. A method for performing a search of an originating database, the method comprising
accepting signals at a first processor to create a context definition, wherein the context definition includes one or more associated terms;
associating a context definition name with the context definition;
sending the context definition to a second processor for selection by a user in a database search, whereby the one or more associated terms are used in connection with a user search term to perform a search of the originating database.
